(19) United States
(12) Patent Application Publication
(10) Pub. No.: US 2012/0262025 A1
(43) Pub. Date: Oct. 18, 2012

(54) Commutator for Power Transmission in an Electric Machine

(75) Inventors: Jan Goehler, Stuttgart (DE); Michael Bayer, Ludwigsburg (DE); Antje Winkelmann, Seeheim-Jugenheim (DE)

(73) Assignee: ROBERT BOSCH GMBH, STUTGART (DE)

(21) Appl. No.: 13/497,250

(22) PCT Filed: Sep. 21, 2010
(86) PCT No.: PCT/EP10/63840

§ 371 Date: Jun. 4, 2012

(30) Foreign Application Priority Data
Sep. 23, 2009 (DE) 10 2009 029 687.5

(51) Int. Cl. H02K 13/00

(52) U.S. Cl. 310/236

(57) ABSTRACT

A commutator for transmitting current in an electric machine is disclosed. The commutator includes an armature-side collector and at least one brush contacting the collector. At least one current-carrying component of the commutator is implemented as porous ceramic body having infiltrated metal.

The invention relates to a commutator for power transmission in an electric machine according to the preamble of claim 1.

### PRIOR ART

In order to transmit power to the armature which is mounted in a rotating fashion in a stator and in order to reverse power in short-circuited armature coils, commutators are used composed of an armature-side collector and carbon brushes bearing on the collector. The housing-fixed carbon brushes bear on the lateral face of the rotating collector, wherein the condition of the material of the commutator components has a significant influence on the power transmission rate from the carbon brush to the collector as well as on the wear of, in particular, the carbon brush.

DE 40 25 367 C2 discloses a metal-filled carbon brush for a small motor which is embodied as a sintered component and is composed of a cleaned graphite powder which is mixed with metal powder, pressure-molded and subsequently sintered.

### DISCLOSURE OF THE INVENTION

The invention is based on the object of forming a commutator in an electric machine in such a way that both a high power transmission level and a long service life are ensured.

This object is achieved according to the invention with the features of claim 1. The dependent claims specify expedient developments.

The commutator according to the invention is used to transmit power and reverse power in electric machines, in particular in electric motors, with use in both direct current motors and in alternating current motors being considered. For example, commutators of this type can be used in direct current starter motors for internal combustion engines, which starter motors are embodied either as electric motors or as permanently excited motors and can be used both for sparking engines and for diesel engines. Furthermore, for example start/stop systems for internal combustion engines are considered, or the use as an electric machine in hybrid vehicles is considered. Further possibilities of use are electric drives, in particular as an actuating motor in vehicles, for example for engine cooling, vehicle air-conditioning or as a windscreen wiper motor. Furthermore, use in electric motors for electric tools is also possible. Use in slip ring rotor asynchronous motors and three phase current generators with a high level of robustness and service life is also conceivable.

The commutator comprises an armature-side collector which is permanently connected to the armature of the electric machine, and at least one brush which bears on the collector and is fixed to the housing and by means of which the power is transmitted to the collector in order to energize armature coils. At least one power-transmitting component of the commutator is embodied as a porous ceramic body with infiltrated metal. The porous ceramic body constitutes a preform which is infiltrated with molten metal during the production process, for example by means of gas pressure infiltration or by means of squeeze cast technology.

The power-transmitting component of the commutator which is embodied in this way is therefore composed of a metal-ceramic composite material which is embodied as a preform-based material (P-MMC) or is manufactured in this way.

The proportion of ceramic in the composite material ensures a high degree of resistance to wear and corrosion, and furthermore a high temperature resistance is achieved (up to 800° C. when Cu is used as a metallic component). The ceramic component reduces the friction during the relative movement between the brush and the collector lateral face, with the result that the resistance to wear is increased.

A further advantage is that even relatively large components with complex geometries can be infiltrated completely with the metal without fractures. As a result, both the brushes and the collector can be manufactured with the respectively desired geometry.

In the commutator according to the invention, at least one commutator component—one or more brushes and/or the collector—is manufactured from the metal-ceramic composite material with the porous ceramic body with infiltrated metal. Both embodiment variants in which only the brushes or only the collector or both the brushes and the collector are manufactured from the metal-ceramic composite material can be considered. If both the brushes and the collector are composed of the composite material, both identical composite materials and different composite materials can be used for the brushes and the collector and/or identical or else different mixture ratios of the proportion of ceramic to the proportion of metal can be used.

Possible ceramic components are oxides, nitrides or carbides, for example Al₂O₃, AlN, TiN, Si₃N₄, SiC or silicon-infiltrated SiC. Preferably highly conductive materials, in particular copper or copper alloys or else silver, gold, aluminum, iron, tin and their alloys are preferably used as metallic components. Furthermore, if necessary lubricant materials and abrasive materials can be added.

The composite material which is embodied as a porous ceramic body with infiltrated metal has, owing to its three-dimensional network structure of the structural constituents, not only the resistance to wear, temperature and corrosion, which is due to the proportion of ceramic, but also a high level of electrical and thermal conductivity. By varying the proportion of ceramic it is possible to generate specific electrical resistances between approximately 0.05 μΩm and 10¹⁵ Ωm.

It may be expedient to manufacture the brush with a plurality of functional layers which are each manufactured as a metal-ceramic composite material but have a different proportion of metal or proportion of ceramic. The junction between these functional layers may optionally be discrete or continuous. The brush is embodied, for example, with two layers with different proportions of metal, wherein the layer which is at the front in the relative direction of movement has, as a power layer, a higher proportion of metal and a higher power transmission rate than the layer at the rear in the relative direction of movement, which layer forms a commutation layer. The comparatively high proportion of ceramic in the commutation layer permits the commutation by virtue of a high tangential resistance, and reduces the formation of sparks which are produced at the trailing edge of the brush.

For a high power transmission rate it is expedient that the power layer, which has a relatively high proportion of metal, has a larger contact cross section compared to the commutation layer, in particular has a greater thickness viewed in the direction of movement, and if appropriate also a greater width transversely with respect to the direction of movement. The relatively large contact area of the power layer permits relatively high power transmission rates.

The collector is expediently also fabricated from a composite material with a comparatively high proportion of metal which permits a high power transmission rate. The composite material from which the collector is fabricated can be at least approximately of the same design as the composite material of the power layer in the brush, but it expediently has a higher proportion of metal than the commutation layer.

The core of the collector can be manufactured as a dense ceramic insulator as a further embodiment feature. For this purpose, the ceramic preform is embodied in such a way that the later running faces of the collector are composed of a freely selectable composition of metal and ceramic. In this context, different mixture ratios of ceramic proportion to metal proportion can be used axially along the segments of the collector in order to produce the electrical contact with the armature winding.

Furthermore, it may be expedient to use a manufacture-related encapsulation on the brush as a brush plate via which the electrical contact occurs using a rigid or flexible electrical conductor (for example stranded conductor). The encapsulation constitutes a layer which at least partially covers the surface of the ceramic body and which can be used as a footplate for securing and making contact with the layers in the brush.

Further advantages and expedient embodiments can be found in the further claims, the description of the figures and the drawings, in which:

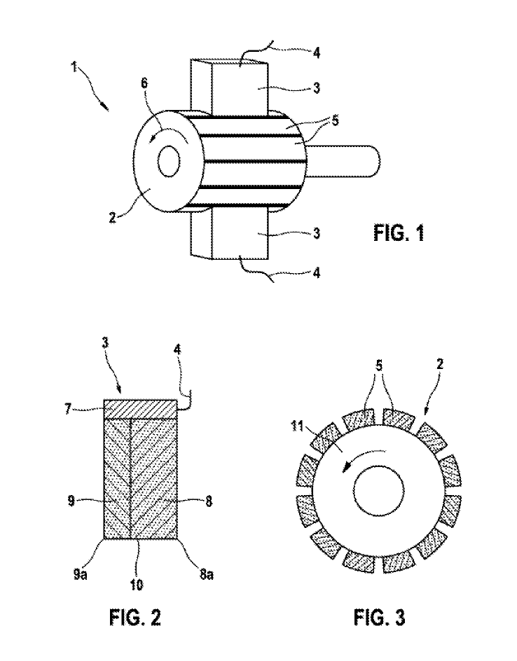

FIG. 1 shows a perspective illustration of a commutator in an electric machine, composed of an armature-side collector and two brushes which lie diametrically opposite one another and make contact with the collector lateral face,

FIG. 2 shows a section through a brush, composed of a metallic brush plate and two layers which are each composed of a metal-ceramic composite material and are embodied as a porous ceramic body with infiltrated metal, and

FIG. 3 shows a section through the collector whose segments are also embodied as a porous ceramic body with infiltrated metal.

The commutator 1 which is illustrated in FIG. 1 is used to transmit power and change power in electric machines such as electric motors and/or generators and comprises a cylindrical collector 2 which is connected in a rotationally fixed fashion to the armature of the electric machine, which armature is rotatably mounted in a stator, as well as brushes 3 which are in contact with the radially outer lateral face of the cylindrical collector 2 or the running face of the disk and transmit current to the collector 2, which current is conducted into the brushes 3 via a stranded conductor 4. The collector 2 can, if appropriate, also be embodied in the form of a disk. Other means of contact such as, for example, metal strips or pressure springs are also possible. In FIG. 1, the commutator 1 has two brushes 3 diametrically opposite one another. However, in principle, commutators with a relatively large number of brushes, for example four or six brushes, are also possible.

The collector 2 has a multiplicity of individual segments 5 which are separated in the circumferential direction and are electrically connected to armature coils. In the case of a rotational movement of the armature or of the collector 2 in the rotational direction 6, the lateral face of the collector moves along the facing end face of the brushes 3, and at the same time the current is transmitted from the brushes 3 to the segments 5 of the collector 2.

FIG. 2 illustrates a section through a brush 3. The feeding in of current via the stranded conductor 4 or a comparable contacting means occurs, if appropriate, into a brush plate 7 which constitutes a footplate and is connected to two layers 8 and 9 of the brush which are embodied as a power layer 8 and a commutation layer 9. With respect to the relative movement between the collector and the brush, the power layer 8 is located at the front and the commutation layer 9 at the rear, and correspondingly 8a denotes the leading edge (front edge) of the brush 3 and 9a denotes the trailing edge (rear edge). During the relative movement between the brush and the collector, the power layer 8 moves into contact in front of the commutation layer 9 with the respective next segment 5 on the collector 2. The end-side contact face of the brush 3, which is in contact with the lateral face of the collector, is provided with reference symbol 10.

Both layers 8 and 9 of the brush 3 are composed of a metal-ceramic composite material and are embodied as a porous ceramic body with infiltrated metal (preform-based metal-matrix composite—P-MMC). This is a porous ceramic preform which is preferably infiltrated with molten metal with pressure assistance by means of gas pressure infiltration or by means of squeeze cast technology. The power layer 8 at the front expediently has a larger contact cross section than the commutation layer 9 at the rear, with the result that in the region of the contact face 10 the power layer 8 is in contact with the lateral face of the collector over a larger area than the commutation layer 9. The relatively large contact cross section is achieved, in particular, by means of a greater width or thickness of the power layer 8 measured in the relative direction of movement. In the exemplary embodiment, the thickness of the power layer 8 is approximately twice as large as the thickness of the commutation layer 9.

The brush plate 7, via which the electrical contact is made by means of the stranded conductor 4 or some other contacting means, can be embodied as an encapsulation which is produced during the casting process when the molten metal is introduced into the porous ceramic preform. The encapsulation constitutes a metal layer on the outer side of the ceramic body and is composed of the same material as the metal introduced into the ceramic body. Oxides, nitrides or carbides are possible as the ceramic component, and copper or a copper alloy is preferably used as the metal. However, further highly conductive metals such as silver, gold, aluminum, iron, tin and alloys thereof are also possible as the metallic component.

The power layer 8 and the commutation layer 9 differ in terms of their proportion of ceramic or proportion of metal. The power layer 8 has a higher proportion of metal than the commutation layer 9, which improves the electrical conductivity of the power layer 8. At the same time, the commutation layer 9 is very wear resistant and temperature resistant owing to the relatively high proportion of ceramic. In addition, the formation of sparks in the region of the trailing edge 9a is reduced owing to the relatively high proportion of ceramic.

FIG. 3 illustrates the collector 2 in section. The segments 5 on the outside of the collector 2, which are respectively separated from one another in the circumferential direction, are also fabricated from a metal-ceramic composite material in the form of a porous ceramic body with infiltrated metal (P-MMC).

1. A commutator for power transmission in an electric machine, comprising:
an armature-side collector; and
at least one brush bearing against the armature-side collector,
wherein at least one of the armature-side collector and the at least one brush is configured as a porous ceramic body with infiltrated metal.

2. The commutator as claimed in claim 1, wherein the at least one brush is the porous ceramic body with infiltrated metal.

3. The commutator as claimed in claim 2, wherein the at least one brush includes a brush plate, and
the brush plate is formed by an encapsulation, which encapsulation is produced during the process of casting metal into the ceramic body.

4. The commutator as claimed in claim 1, wherein the armature-side collector is configured at least partially as the porous ceramic body with infiltrated metal.

5. The commutator as claimed in claim 4, wherein:
the armature-side collector includes a core, and
the core is configured as a ceramic insulator, which is the carrier of segments which are formed as the porous ceramic body with infiltrated metal.

6. The commutator as claimed in claim 1, wherein at least one of the armature-side collector and the at least one brush has at least two layers with a differing metal-ceramic component in the metal-ceramic composite material.

7. The commutator as claimed in claim 2, wherein the at least one brush has two layers with a different proportion of metal, and the layer which is at the front with respect to the relative movement between the armature-side collector and the at least one brush has, as a power layer, a larger proportion of metal than the layer lying at the rear, which layer forms a commutation layer.

8. The commutator as claimed in claim 7, wherein the power layer has a larger contact cross section, with which the at least one brush is in contact with the armature-side collector, than the commutation layer.

9. The commutator as claimed in claim 4, wherein the proportion of metal in the armature-side collector has at least approximately the same proportion of metal as the power layer in the at least one brush.

10. The commutator as claimed in claim 4, wherein the proportion of metal in the armature-side collector is higher than the proportion of metal in the commutation layer in the at least one brush.

11. The commutator as claimed in claim 1, wherein the porous ceramic body is made of oxides, nitrides or carbides.

12. The commutator as claimed in claim 11, wherein the infiltrated metal is made of copper and/or a copper alloy.

13. An electric machine having a commutator that comprises:
an armature-side collector; and
at least one brush bearing against the armature-side collector,
wherein at least one of the armature-side collector and the at least one brush is configured as a porous ceramic body with infiltrated metal.
